(19) United States
(12) Patent Application Publication
(10) Pub. No.: US 2006/0128940 A1
(43) Pub. Date: Jun. 15, 2006

(54) Luminescent orgainc-polymer/metal complex, luminescent orgainc-polymer/metal complex composition capable of forming film by wet process, and process for producing the same

(76) Inventors: Yasushi Kobayashi, Shinagawa-ku (JP); Kazuaki Kudo, Meguro-ku (JP); Toshio Takayama, Meguro-ku (JP); Hiroshi Sano, Shinagawa-ku (JP)

Correspondence Address: BIRCH STEWART KOLASCH & BIRCH, PO BOX 747, FALLS CHURCH, VA, 22040-0747, US

(21) Appl. No.: 10/559,129

(22) PCT Filed: Jun. 1, 2004
(86) PCT No.: PCT/JP04/07904

§ 371 Date: Dec. 1, 2005

(30) Foreign Application Priority Data
Jun. 2, 2003 (JP) 2003156790
Sep. 3, 2003 (JP) 2003311117

(51) Int. Cl. C08G 73/00

(52) U.S. Cl. 528/422

(57) ABSTRACT

This invention provides a luminescent organic polymer metal complex represented by polyQ.M.Kₙ₋₁ (1) which is obtained by the reaction of a polymer ligand (polyQ) with an 8-hydroxyquinoline derivative introduced to its side chain through a spacer group, an 8-hydroxyquinoline derivative ligand (K) and a divalent to tetravalent metal ion (Mⁿ⁺) wherein the 8-hydroxyquinoline derivative ligand (K) has a bulky substituent. This invention also provides a luminescent organic polymer metal complex composition comprising said luminescent organic polymer metal complex and additionally a low-molecular-weight ligand and a process for producing the same.

### FIELD OF TECHNOLOGY

This invention relates to a novel luminescent organic polymer metal complex and a composition comprising said luminescent organic polymer metal complex and formable into film by a wet process and to a process for producing the same and, more particularly, this invention relates to a luminescent organic polymer metal complex useful as a material for the luminescent layer of an organic electroluminescent element (organic EL element) and a luminescent organic polymer metal complex composition formable into film by a wet process and to a process for producing the same.

### BACKGROUND TECHNOLOGY

Organic El elements are capable of exhibiting surface luminescence and potentially allow manufacture of large-area luminescent elements and they are expected to find applications in displays of television, personal computers, family computers and the like, backlight of liquid crystal displays and a variety of advertising towers and indicator lamps.

In particular, from the time when tris(8-hydroxyquinolinato)aluminum (Alq₃) was reported to be a material having both electron-transporting and light-emitting abilities for the first time, a large number of studies have been made on aluminum complexes containing 8-hydroxyquinoline or its derivative as a ligand. Moreover, a large number of organic metal complexes other than Alq₃ and its derivatives have also been reported as materials for organic EL elements.

Now, Alq₃ excels in fastness, polychroism, brightness and the like and still retains its importance even today, but it faces problems such as the following. When used in an organic EL element, Alq₃ must be formed into a thin film on a substrate by vacuum deposition and the larger the area of a luminescent element, the larger an apparatus for vacuum deposition becomes; that is, this compound is not suited for the manufacture of large-area luminescent elements. Moreover, Alq₃ gradually crystallizes due to thermal motion while acting as a luminescent element and suffers losses in durability and service life.

One of the methods known to solve the aforementioned problems is to coordinate a polymer itself as a ligand to a metal ion: for example, it is proposed that a solution of tris[5-(methacryloyloxyethoxymethyl)-8-hydroxyquinolinato]aluminum which has been obtained by introducing a polymerizable group to Alq₃ is applied to a substrate by the spin coating process and then photopolymerized on the spot to form an insoluble highly crosslinked thin film on the substrate (W002/068560 pamphlet). However, this method uses a photopolymerization initiator to effect on-the-spot photopolymerization of the polymerizable group on the substrate and there is the possibility that this photopolymerization initiator becomes taken in the thin film being formed on the substrate and hinders emission of light and, further, the change in volume during polymerization distorts the thin film and the film tends to peel off easily.

According to another known method, a polymer metal complex comprising a polymer ligand and a low-molecular-weight ligand and soluble in solvents is prepared and used to form a thin film on the substrate. For example, the following polymers are proposed for such ligands; a polymer prepared by introducing 8-hydroxyquinoline group to the side chain of a polyethersulfone through an imide linkage [Journal of Polymer Science, Part A: Polymer Chemistry, vol. 38, p. 2887 (2000)] and a polymer obtained by first preparing an XAlq₂ type complex monomer by linking the position 5 of one of 8-hydroxyquinoline groups in Alq₃ to the position 5 of norbornane through the spacer group [—CH₂NH(CH₂)₆—] and polymerizing the monomer by ring-opening metathesis [Macromolecules, vol. 36, p. 1766 (2003)]. However, these polymers are copolymers that contain a repeating unit linked to an aluminum complex and another repeating unit free of an aluminum complex and they face such problems as difficulty in introducing aluminum complexes in high proportion to the repeating unit of the polymer and low efficiency as electroluminescent elements.

Still more, the reaction product of a polymer containing an amino group with an aromatic compound containing aldehyde and hydroxyl groups (JP2001-131,542A and JP2001-185,357A) or a polymer containing a B-diketone group as a ligand in its side chain (JP2001-185,357A and JP2001-220,579A) is proposed for the aforementioned polymer ligand. However, the polymers cited here do not contain 8-hydroxyquinoline as a ligand in their side chains. In consideration of the fact that Alq₃ is a luminescent material with a particularly high electron-transporting ability and of the aforementioned merits of polymer luminescent materials, there is a strong demand for development of ligands containing 8-hydroxyquinoline derivatives in their side chains.

### DISCLOSURE OF THE INVENTION

The inventors of this invention have conducted intensive studies on luminescent organic polymer metal complexes of the Alq₃ type which exhibit excellent fastness, polychroism, brightness and the like characteristic of Alq₃, contain polymer ligands and low-molecular-weight ligands, are readily soluble in solvents and allow manufacture of large-area thin film by a wet process, found surprisingly that the use of an 8-hydroxyquinoline derivative having a bulky substituent as a low-molecular-weight ligand provides excellent solvent solubility suitable for manufacture of thin film by a wet process even when a homopolymer ligand containing an 8-hydroxyquinoline group is used as a polymer ligand and completed this invention.

The inventors of this invention have further found that the incorporation of a luminescent organic metal complex of the Alq₃ type containing only an 8-hydroxyquinoline derivative having a bulky substituent as a low-molecular-weight ligand in a luminescent organic polymer metal complex of the Alq₃ type containing a polymer ligand and a low-molecular-weight ligand improves the solvent solubility of the luminescent organic polymer metal complex and provides a luminescent organic polymer metal complex composition suitable for formation of film by a wet process and completed this invention.

Accordingly, an object of this invention is to provide a luminescent organic polymer metal complex of the Alq₃ type which contains a polymer ligand and a low-molecular-weight ligand, shows excellent solvent solubility and is suitable for formation of film by a wet process.

Another object of this invention is to provide a luminescent organic polymer metal complex composition which comprises the aforementioned luminescent organic polymer metal complex of the Alq₃ type containing a polymer ligand and a low-molecular-weight ligand, shows excellent solvent solubility and is capable of forming film by a wet process.

A further object of this invention is to provide a process for producing the aforementioned luminescent organic polymer metal complexe and a composition thereof.

This invention relates to a luminescent organic polymer metal complex obtained by the reaction of a polymer ligand (polyQ) having a repeating unit (Y) with an 8-hydroxyquinoline derivative (Q) introduced to its side chain, if necessary, through a spacer group (X), a low-molecular-weight ligand (K) consisting of an 8-hydroxyquinoline derivative (K) and a divalent to tetravalent metal ion (Mⁿ⁺) and represented by the following general formula (1)
polyQ.M.Kₙ₋₁ (1)
wherein said 8-hydroxyquinoline derivative (K) is represented by the following general formula (2); 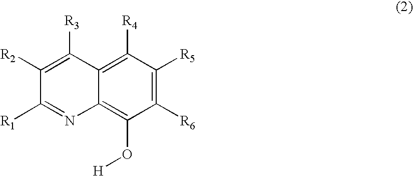
in formula (2), R₁—R₆ are substituents selected from hydrogen, halogens, saturated or unsaturated hydrocarbon groups containing 1-20 carbon atoms and having a linear, branched or annular structure or a mixed structure thereof, alkoxy groups containing 1-20 carbon atoms, alkylamino groups containing 1-20 carbon atoms, alkylthio groups containing 1-20 carbon atoms, alkylsulfonyl groups containing 1-20 carbon atoms, alkyloxyalkyl groups containing 2-20 carbon atoms, alkylthioalkyl groups containing 2-20 carbon atoms, alkanoyl groups containing 2-20 carbon atoms, aroyl groups, monoalkylaminoalkyl groups containing 2-20 carbon atoms, dialkylaminoalkyl groups containing 3-20 carbon atoms, phenylazo groups whose functional groups are substituted or unsubstituted, anilinoalkyl groups whose functional groups are substituted or unsubstituted and —SO₃Na and at least one of the substituents R₁, R₃, R₄ and R₆ is a bulky substituent other than hydrogen, halogens and —SO₃Na.

This invention also relates to a luminescent organic polymer metal complex composition which comprises a polymer metal complex (HM-C) represented by the aforementioned general formula (1) and a low-molecular-weight metal complex (LM-C) represented by the following general formula (3) in which only the aforementioned low-molecular-weight ligand (K) consisting of the aforementioned 8-hydroxyquinoline derivative (K) is coordinated to a divalent to tetravalent metal ion (Mⁿ⁺):
M.Kₙ (3)

Further, this invention relates to a process for producing a luminescent organic polymer metal complex composition formable into film by a wet process which comprises reacting 1 equivalent of a compound of a divalent to tetravalent metal, 0.1-1 equivalent of a polymer ligand (polyQ) having a repeating unit (Y) with an 8-hydroxyquinoline derivative (Q) introduced to its side chain, if necessary, through a spacer group (X) and 1-3.9 equivalents of low-molecular-weight ligand (K) consisting of an 8-hydroxyquinoline derivative (K) represented by the aforementioned general formula (2) in a solvent to give a composition containing a polymer metal complex (HM-C) represented by the aforementioned general formula (1) in which a polymer ligand (polyQ) and a low-molecular-weight ligand (K) are coordinated to a divalent to tetravalent metal ion (Mⁿ⁺) and a low-molecular-weight metal complex (LM-C) represented by the aforementioned formula (3) in which only a low-molecular-weight ligand (K) is coordinated to a divalent to tetravalent metal ion (Mⁿ⁺).

According to this invention, a polymer ligand (polyQ) used for the production of a polymer metal complex (HM-C) represented by formula (1) is a polymer having a repeating unit (Y) in which a complex-forming 8-hydroxyquinoline derivative (Q) is introduced, if necessary, through a spacer group (X). The polymer ligand (polyQ) may be a polymer having one kind of repeating unit (Y) or a copolymer having two kinds or more of repeating unit (Y).

The repeating unit (Y) constituting the polymer in the polymer metal complex (HM-C) is subject to no specific restrictions other than that an 8-hydroxyquinoline derivative (Q) can be introduced to the repeating unit, if necessary, through a spacer group (X); for example, the polymer in question can be prepared by addition polymerization, polycondensation or ring-opening metathetical polymerization. Examples are repeating units (ethylenic linkage) derived from acrylic acid compounds such as acrylate esters, methacrylate esters, acrylamide and methacrylamide, vinyl esters such as vinyl acetate, N-vinyllactams such as N-vinylpyrrolidone, vinyl ethers, allyl esters, allyl ethers and vinyl aromatic compounds such as styrene, repeating units derived from a variety of dienes such as butadiene and isoprene and those derived from amides, imides, esters, ethersulfones and vinylcyclopentane. The repeating units derived from methacrylate esters, styrene and vinylcyclopentane are preferred.

The aforementioned spacer group (X), provided wherever necessary in forming a polymer ligand (polyQ) is a group linking the backbone of a polymer consisting of a repeating unit (Y) to the quinoline nucleus of an 8-hydroxyquinoline derivative (Q) and it can be provided in several ways. A substituent capable of linking to an 8-hydroxyquinoline derivative (Q) can be introduced as a spacer group to the monomer which is to polymerize to constitute a repeating unit (Y); conversely, a substituent capable of linking to the monomer is first introduced to the 8-hydroxyquinoline derivative (Q); or, substituents capable of reacting with each other to form a linkage are introduced respectively to the monomer and 8-hydroxyquinoline derivative (Q). Preferably, the spacer group contains linearly linked 0-15 atoms, preferably 5-10 atoms, of carbon, hydrogen, halogen, oxygen, nitrogen, sulfur, silicon and phosphorus and it may be a diol such as ethylene glycol, a diamine such as ethylenediamine or an alkyl/aryl chain.

The derivatives of 8-hydroxyquinoline having the following substituents at one or two or more of the positions 2 to 7 are useful as an 8-hydroxyquinoline derivative (Q) constituting the aforementioned polymer ligand (polyQ): halogens, saturated or unsaturated hydrocarbon groups containing 1-20 carbon atoms and having a linear, branched or annular structure or a mixed structure thereof, alkoxy groups containing 1-20 carbon atoms, alkylamino groups containing 1-20 carbon atoms, alkylthio groups containing 1-20 carbon atoms, alkylsulfonyl groups containing 1-20 carbon atoms, alkyloxyalkyl groups containing 2-20 carbon atoms, alkylthioalkyl groups containing 2-20 carbon atoms, alkanoyl groups containing 2-20 carbon atoms, aroyl groups, monoalkylaminoalkyl groups containing 2-20 carbon atoms, dialkylaminoalkyl groups containing 3-20 carbon atoms, phenylazo groups whose functional groups are substituted or unsubstituted, anilinoalkyl groups whose functional groups are substituted or unsubstituted and —SO₃Na. In case the number of substituents is two or more, they may be identical with or different from each other.

The process for producing the polymer ligand (polyQ) is not restricted. For example, a polymerizable alkoxy (meth)acrylate group is introduced to an 8-hydroxyquinoline derivative (Q) by chloromethylation followed by reaction with a hydroxyalkyl (meth)acrylate and the resulting 8-hydroxyquinoline derivative containing the alkoxy (meth)acrylate group is polymerized in the presence of a radical initiator such as AIBN (refer to patent literature 1). Alternatively, a diamine having an 8-hydroxyquinoline group is polycondensed to give a polyamide or polyimide or a norbornane derivative having an 8-hydroxyquinoline group is polymerized readily by ring-opening metathesis in the presence of a ruthenium catalyst.

In the course of the polymerization of the aforementioned 8-hydroxyquinoline derivative (Q) containing a polymerizable substituent in the presence of a radical initiator for the production of the polymer ligand (polyQ), there may develop a situation where the 8-hydroxyquinoline derivative (Q) is a phenolic compound capable of capturing radicals and, when submitted to the polymerization with the hydroxyl group bare at the position 8, the hydroxyl group captures radicals and retards the polymerization reaction. In such a case, it is preferable to adopt the following procedure; the hydroxyl group at the position 8 of the 8-hydroxyquinoline derivative (Q) containing a polymerizable substituent is treated with a trialkylsilyl halide to introduce a trialkylsilyl group to the position 8, the resulting derivative is polymerized in the presence of a radical initiator such as AIBN to effect the polymerization of the alkoxy (meth)acrylate group and thereafter the trialylsilyl group is eliminated from the polymer.

The formation of a polymer metal complex (HM-C) represented by the aforementioned formula (1) requires a low-molecular-weight ligand (K) consisting of an 8-hydroxyquinoline derivative (K) represented by the aforementioned formula (2) and the substituents R₁—R₆ are selected from hydrogen, halogens, saturated or unsaturated hydrocarbon groups containing 1-20 carbon atoms and having a linear, branched or annular structure or a mixed structure thereof, alkoxy groups containing 1-20 carbon atoms, alkylamino groups containing 1-20 carbon atoms, alkylthio groups containing 1-20 carbon atoms, alkylsulfonyl groups containing 1-20 carbon atoms, alkyloxyalkyl groups containing 2-20 carbon atoms, alkylthioalkyl groups containing 2-20 carbon atoms, alkanoyl groups containing 2-20 carbon atoms, aroyl groups, nonoalkylaminoalkyl groups containing 2-20 carbon atoms, dialkylaminoalkyl groups containing 3-20 carbon atoms, phenylazo groups whose functional groups are substituted or unsubstituted, anilinoalkyl groups whose functional groups are substituted or unsubstituted and —SO₃Na; at least one of R₁, R₃, R₄ and R₆ is a bulkyl substituent other than hydrogen, halogens and —SO₃Na; preferably, at least one of the substituents R₁, R₄ and R₆ is a bulky substituent selected from saturated or unsaturated hydrocarbon groups containing 6-20 carbon atoms and having a linear, branched or annular structure or a mixed structure thereof, alkyloxyalkyl groups containing 2-20 carbon atoms, alkanoyl groups containing 2-20 carbon atoms, dialkylaminoalkyl groups containing -2-20 carbon atoms, phenylazo groups whose functional groups are substituted or unsubstituted and anilinoalkyl groups whose functional groups are substituted or unsubstituted and particularly preferred derivatives are 7-(ethyl-1-methyloctyl)-8-hydroxyquinoline and 7-(1-vinyl-3,3,6,6-tetramethylhexyl)-8-hydroxyquinoline.

The divalent to tetravalent metal ions (Mⁿ⁺) constituting the aforementioned polymer metal complex (HM-C) can be chosen freely from the metal ions used hitherto in organic metal complexes of this kind; for example, aluminum ions (Al₃₊), beryllium ions (Be²⁺), cadmium ions (Cd²⁺), cerium ions (Ce³⁺), cobalt ions (Co³⁺), chromium ions (Cr³⁺), copper ions (Cu²⁺), iron ions (Fe³⁺), gallium ions (Ga³⁺), germanium ions (Ge⁴⁺), indium ions (In²⁺), manganese ions (Mn²⁺), nickel ions (Ni²⁺), ruthenium ions (Ru³⁺), osmium ions (Os³⁺) and titanium ions (Ti⁴⁺). Preferred are aluminum ions (Al³⁺), gallium ions (Ga³⁺) and beryllium ions (Be²⁺). In the cases where aluminum ions (Al³⁺) are used, the aluminum compounds useful for the synthesis of the aforementioned polymer metal complex (HM-C) are trialkylaluminums such as trimethylaluminum and triethylaluminum and trialkoxyaluminums such as triisopropoxyaluminum.

According to this invention, an organic polymer metal complex (HM-C) represented by the aforementioned formula (1) shows excellent solubility in a variety of solvents by itself and can singly be formed into film by a wet process; in some cases, however, mixing it with a low-molecular-weight complex (LM-C) represented by the aforementioned formula (3) may further improve its solvent solubility.

Thus, a luminescent organic metal complex composition prepared according to this invention comprises a polymer metal complex (HM-C) represented by the aforementioned formula (1) and a low-molecular-weight metal complex (LM-C) represented by the aforementioned formula (3) as principal components. In the low-molecular-weight metal complex (LM-C), only a low-molecular-weight ligand (K) consisting of an 8-hydroxyquinoline derivative (K) is coordinated to a divalent to tetravalent metal ion (Mⁿ⁺), the low-molecular-weight ligand (K) and the metal ion being the same as in the polymer metal complex (HM-C).

A variety of luminescent organic metal complex compositions can be obtained by preparing polymer metal complexes (HM-C) and low-molecular-weight metal complexes (LM-C) separately and dissolving them in a specified solvent at a specified ratio while making use of various combinations of polymer metal complexes (HM-C), low-molecular-weight compound metal complexes (LM-C) and metal ions (M³⁺). A composition in which the same metal ion (Mⁿ⁺) and the same low-molecular-weight ligand (K) are used in both polymer metal complex (HM-C) and low-molecular-weight metal complex (LMC) can be prepared easily by reacting 1 equivalent of a compound of a divalent to tetravalent metal, 0.1-1 equivalent, preferably 0.2-0.5 equivalent, of a polymer ligand (polyQ) and 1-3.9 equivalents, preferably 1.5-2.8 equivalents, of a low-molecular-weight ligand (K) in a specified solvent.

The ratio of the polymer metal complex (HM-C) to the low-molecular-weight metal complex (LM-C) in this luminescent organic metal complex composition is not limited; however, from the viewpoint of solvent solubility and mechanical strength of film, the molar ratio (HM-C)/(LM-C) is controlled normally at 0.2 or more, preferably at 0.5 or more.

Solvents which are inert to polymer metal complexes (HN—C) and low-molecular-weight metal complexes (LM-C) and capable of dissolving the two can be used in the preparation of the aforementioned luminescent organic metal complex compositions; for example, chlorine-containing solvents such as chloroform, methylene chloride and dichloroethane, ethers such as tetrahydrofuran, aromatic hydrocarbons such as toluene and xylene, ketones such as acetone and methyl ethyl ketone and esters such as ethyl acetate, butyl acetate and ethyl cellosolve acetate.

In forming film from a luminescent organic metal complex composition according to this invention, it is allowable to add a low-molecular-weight coloring matter or a low-molecular-weight compound capable of transporting holes to a solution of the composition, if necessary.

The coloring matters useful for this purpose include nile red, coumarin 6 and quinacridone while the compounds capable of transporting holes include 1,1-bis [4-[N,N′-di(p-tolyl)amino]phenyl]cyclohexane and N,N′-diphenyl-N,N′-di(m-tolyl)benzidine.

In the preparation of film from a luminescent organic metal complex composition containing a polymer metal complex (HM-C) or a polymer metal complex (HM-C) and a low-molecular-weight metal complex (LM-C) according to this invention, it is possible to use any of the publicly known processes suitable for the purpose; for example, spin coating, casting, gravure coating, microgravure coating, bar coating, wire bar coating, roll coating, dip coating, spray coating, screen printing, flexo printing, offset printing and ink jet printing.

A luminescent organic polymer metal complex and a composition thereof prepared according to this invention comprise an organic metal complex of the Alq₃ type, but they show excellent solvent solubility suitable for forming large-area film by a wet process while retaining excellent properties such as fastness, polychroism and brightness characteristic of Alq₃ and they are industrially extremely useful.

### BRIEF DESCRIPTION OF THE DRAWINGS

FIG. 1 shows the synthetic route used in the examples of this invention for the production of luminescent organic polymer metal complexes.

FIG. 2 shows two ¹H-NMR spectra (400 MHz, CDCl₃) obtained in Example 1: the spectrum (A) refers to the reaction mixture (organic polymer metal complex composition) and the specturm (B) to the low-molecular-weight metal complex (LM-C, Al—K₃).

FIG. 3 shows two ¹H-NMR spectra: the spectrum (A) is the differential spectrum of the reaction mixture and the low molecular-weight metal complex (LM-C, Al—K₃) of Example 1 shown in FIG. 1 and the spectrum (B) is that of the polymer ligand (polyQ¹) alone.

FIG. 4 shows the ¹H-NMR spectrum (400 MHz, CDCl₃) of the polymer metal complex (polyQ²-Al—K₂) of Example 3.

FIG. 5 shows the IR spectrum of the polymer metal complex (polyQ²-Al—K₂) of Example 3.

### PREFERRED EMBODIMENTS OF THE INVENTION

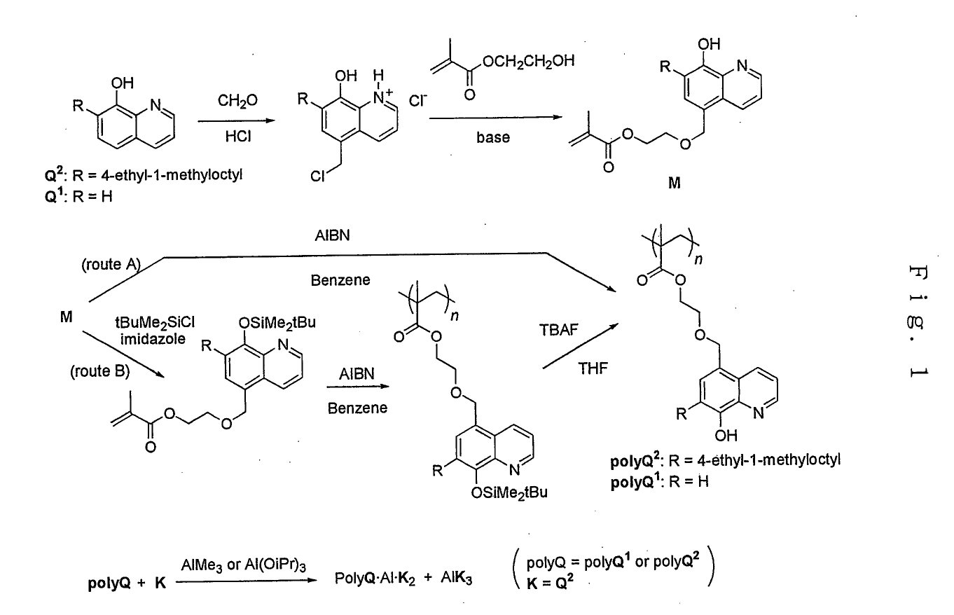

A preferred mode of execution of this invention will be described concretely below with reference to the synthetic route shown in FIG. 1.

[Synthesis of Polymer Ligand (polyQ)]

### SYNTHETIC EXAMPLE 1

### Synthesis of polyQ 1

In a reaction vessel were placed 26.2 g (0.201 mole) of 8-hydroxyquinoline (Q¹), 36 mL of concentrated hydrochloric acid and 32 mL (0.3 mole) of 28 wt % formalin and dry hydrogen chloride gas was introduced to the mixture at room temperature for 90 minutes.

After the reaction was over, the precipitates formed were collected by filtration and dried to give 37.2 g (yield 80%) of the chloromethylated product (Q¹-CH₂Cl.HCl) as an amorphous yellow solid. The melting point of the product was 280° C. (with decomposition) and agreed well with the literature value [280° C. (with decomposition), J. Org. Chem., vol. 26, p. 4078 (1961)].

Following this, 14.5 g (0.0629 mole) of the chloromethylated product (Q¹-CH₂Cl.HCl) and 60 mL (0.43 mole) of 2-hydroxyethyl methacrylate, in excess of the chloromethylated product, were placed in a reaction vessel and they were allowed to react at 60° C. for 2 days in an atmosphere of argon.

Upon completion of the reaction, the reaction mixture was allowed to cool to room temperature, 150 mL of water was added, the mixture was then made alkaline by addition of dilute ammonia water and the precipitates were collected by filtration, washed with dilute ammonia water and dried in vacuum overnight.

The crude product was dissolved in 650 mL of tetrahydrofuran (THF), the insoluble matters were filtered off, the filtrate was concentrated under reduced pressure and the solid obtained was recrystallized twice from hexane to give 12.5 g (43.5 millimoles, yield 69%) of a product (Q¹-CH₂—HMA) containing 2-ethoxy methacrylate group. The melting point of the product was 89.2-89.5° C. and agreed well with the literature value (89° C.).

In 55 ml of benzene were dissolved 7.00 g (24.4 millimoles) of the product (Q¹-CH₂—HMA) and 231 mg (1.4 millimoles) of AIBN, the solution was sealed in an ampoule in an atmosphere of argon and the ampoule was heated in an oil bath at 65° C. for 20 minutes and then allowed to cool for 1 hour to room temperature.

The ampoule was opened and stripped of the benzene and a light green resinous solid remaining at the bottom of the ampoule was dissolved in 50 mL of DMF, filtered and reprecipitated by addition of 2 L of methanol to give 3.75 g (yield 54%) of a white solid polymer (polymer ligand, polyQ 1)

The ¹H-NMR data of the polymer (polyQ¹) were as follows.

¹H-NMR (400 MHz, CDCl₃): δ (ppm)=0.75 (br. s, 3H), 1.67 (br. s, 2H), 3.35 (br. s, 2H), 3.90 (br. s, 2H), 4.58 (br. s, 2H), 6.89 (br. s, 1H), 7.21 (br. s, 1H), 7.33 (br. s, 1H), 8.25 (br. s, 1H), 8.66 (br. s, 1H), 9.73 (br. s, 1H).

### SYNTHETIC EXAMPLE 2

### Synthesis of polyQ²

In a reaction vessel were placed 45.0 g (0.15 mole) of 7-(4-ethyl-1-methyloctyl)-8-hydroxyquinoline (Q²), 75 mL of concentrated hydrochloric acid and 25 mL (0.23 mole) of 28 wt % formalin and dry hydrogen chloride gas was introduced to the mixture at 65-75° C. for 17 hours. The reaction product was a mixture of an aqueous layer and a dark ocherous solid.

After the reaction was over, the product was extracted four times with 100 ml of chloroform from which the stabilizer had been removed in advance and the product was reprecipitated by addition of 4 L of ether to give 23 g of an amorphous yellow solid.

The product was identified as Q²-CH₂Cl.HCl (yield 57%) or Q² chloromethylated at the position 5 on the basis of its ¹H-NMR and ¹³C-NMR spectra.

¹H-NMR (400 MHz, CDCl₃): δ (ppm)=9.14 (1H, d, J=7.2 Hz), 9.04 (1H, br. s), 7.99 (1H, br. s), 7.75 (1H, s), 8.06 (2H, s), 3.68 (1H, m), 1.64 (2H, br. d, J=5.6 Hz), 1.31-1.18 (14H, m), 0.87-0.75 (6H, m).

¹³C-NMR (400 MHz, CDCl₃): δ (ppm)=146, 142, 141, 140, 132, 130, 127, 125, 120, 43, 39, 34, 32.9, 32.6, 31, 29, 26, 23, 21, 14, 11.

Thereafter, 10.0 g (0.026 mole) of the chloromethylated product (Q².CH₂Cl.HCl) and 25 mL (0.21 mole) of 2-hydroxyethyl methacrylate (HMA), in excess of the chloromethylated product, were placed in a reaction vessel and the mixture was allowed to react at 60-65° C. for approximately 60 hours in an atmosphere of argon.

After the reaction was over, 400 mL of water was added to the reaction mixture with stirring, then 5 wt % ammonia water was added to the mixture to adjust the pH at 10 or thereabouts, the mixture was left standing, the aqueous layer was removed by decantation, and the remaining white viscous solid was extracted with chloroform and submitted to silica gel chromatography (benzene-cyclohexane) to isolate 6.2 g (yield 54%) of a light green viscous liquid.

The product thus obtained was identified as Q².CH₂.HMA or Q² to which the 2-ethoxy methacrylate group had been introduced on the basis of the following ¹H-NMR and ¹³C-NMR spectral data.

¹H-NMR (400 MHz, CDCl₃): δ (ppm)=8.76 (1H, d, 4 Hz), 8.46 (1H, d. 8.4 Hz), 7.90 (1H, dd, 8.4, 4.2 Hz), 7.26 (1H, s), 6.07 (1H, s), 5.55 (1H, s), 4.90 (2H, s), 4.31 (2H, t, 4.8 Hz), 3.73 (2H, t, 4.8 Hz), 3.36 (1H, q), 1.92 (3H, s), 1.69-1.62 (2H, m), 1.32-0.75 (20H, m).

¹³C-NMR (400 MHz, CDCl₃): δ (ppm)=167, 149, 147, 139, 136, 133, 127.9, 127.6, 126, 123, 121, 72, 67, 64, 39, 34, 33, 31, 29, 26, 23, 21, 18, 14, 11.

In 35 mL of benzene were dissolved 6.2 g (14 millimoles) of the product (Q²-CH₂—HMA) and 155 mg (1 millimole) of AIBN, the solution was introduced to an ampoule in an atmosphere of argon, sealed and allowed to react at 65-75° C. for 10 hours.

After the reaction was over, the ampoule was opened, the reaction mixture was diluted by addition of 100 mL of benzene and added dropwise with stirring to 1 L of methanol to precipitate the product. The methanol was removed by decantation, the precipitates were extracted with benzene, the extract was stripped of the solvent and dried in vacuum at 60° C. for 12 hours to give 2.9 g (yield 47%) of a polymer (polymer ligand, polyQ²) as a light green resinous solid.

The ¹H-NMR spectral data of the polymer (polyQ²) were as follows.

¹H-NMR (400 MHz, CDCl₃): δ (ppm)=8.5 & 8.3 (2H, br), 7.25 (2H, br), 4.69 (2H, br), 4.00 (2H, br), 3.5 & 3.3 (2H, br), 1.5-2.5 (3H, br), 1.5-0.7 (25H, br. m).

### SYNTHETIC EXAMPLE 3

### Synthesis of polyQ²

In 5 mL of dry DMF were dissolved 2.13 g (4.82 millimoles) of the product (Q²-CH₂—HMA) prepared as in the aforementioned Synthetic Example 2 and 0.872 g (5.79 millimoles) of tert-butyldimethylsilyl chloride, 0.82 g (12.0 millimoles) of imidazole was added to the resulting solution with stirring at room temperature, the mixture was stirred continuously at room temperature for 10 hours, the reaction was terminated by addition of a saturated aqueous solution of bicarbonate of soda and the reaction mixture was extracted with hexane. The organic layer obtained was dried and purified by silica gel chromatography (hexane-ethyl acetate) to give 2.68 g (yield 99% or more) of a colorless oily product [Q²(OSi)—CH₂—HMA] or Q²-CH₂—HMA whose hydroxyl group at the position 8 had been silylated.

The ¹H-NMR spectral data of the product [Q²(OSi)—CH₂—HMA] were as follows.

¹H-NMR (400 MHz, CDCl₃): δ (ppm)=8.76 (1H, dd, 2, 4 Hz), 8.41 (1H, dd. 2, 9 Hz), 7.35 (1H, s), 7.32 (1H, dd, 4, 9 Hz), 6.08 (1H, br. s), 5.55 (1H, quintet, 1 Hz), 4.91 (2H, s), 4.32 (2H, t, 5 Hz), 3.74 (2H, t, 5 Hz), 3.62 (1H, sextet, 7 Hz), 1.93 (3H, s), 1.7-0.7 (22H, m), 1.08 (9H, s), 0.38 (3H, s), 0.30 (3H, s).

Thereafter, 1.5 g (2.7 millimoles) of the product [Q²(OSi)—CH₂—HMA] obtained above and 22 mg (0.14 millimole) of AIBN were dissolved in 20 mL of benzene and the solution was sealed in an ampoule in an atmosphere of argon and heated at 65-75° C. for 10 hours. The reaction mixture was diluted with 50 mL of benzene and added dropwise with stirring to 400 mL of methanol to precipitate the product. The methanol was removed by decantation, the precipitates were extracted with ether and the extract was stripped of the solvent and dried under reduced pressure to give 600 mg of a polymer [polyQ²(OSi)] as an amorphous light yellow solid.

The ¹H-NMR spectral data of the polymer [polyQ²(OSi)] were as follows.

¹H-NMR (400 MHz, CDCl₃): δ (ppm)=8.7-8.5 (1H, br), 8.4-8.2 (1H, br), 7.4-7.1 (2H, br), 4.75 (2H, br), 4.05 (2H, br), 3.54 (2H, br), 1.96 (1H, br), 1.5-0.9 (29H, br. m), 0.8-0.6 (6H, br. m), 0.4-0.2 (6H, br. m).

In 30 mL of THF was dissolved 300 mg of the polymer [polyQ²(OSi)], 2 equivalents of tetrabutylammonium fluoride was added to the solution and stirred at room temperature for 10 minutes. The reaction was terminated by addition of a saturated aqueous solution of ammonium chloride and the reaction mixture was separated by treating with ether and water. The organic layer was dried and stripped of the solvent and the highly viscous residue was dissolved again in ether. Upon addition of methanol to the solution, a light green solid precipitated out gradually. The solid was collected by filtration and dried to give 215 mg of a polymer (polymer ligand, polyQ²).

The ¹H-NMR spectral data of the polymer (polyQ²) were as follows.

¹H-NMR (400 MHz, CDCl₃): δ (ppm)=8.66 (1H, br. s), 8.73 (1H, br. s), 7.28 (2H, br), 4.77 (2H, br. s), 4.04 (2H, br), 3.55 (2H, br), 3.32 (1H, br. s), 2.1-0.7 (27H, br. m).

The intrinsic viscosity [η] of the polymer measured by viscometry was 0.24 (THF).

### Example 1

### Synthesis of Composition polyQ¹-Al—K₂+Al—K₃

In a reaction vessel were placed 800 mg (2.78 millimoles) of the polymer ligand (polyQ¹) obtained in Synthetic Example 1, 6.64 g (22.3 millimoles) of 7-(4-ethyl-1-methyloctyl)-8-hydroxyquinoline as a low-molecular-weight ligand (K) and 100 mL of dry THF, the solution was cooled in a dry ice-acetone cooling bath in an atmosphere of argon, 8.4 mL of a solution of trimethylaluminum (AlMe₃) in hexane with a concentration of 1.00 mole/L or 8.4 millimoles of AlMe3 was added in small portions to the solution with stirring and the solution was stirred for another 30 minutes after the addition was over. The solution turned gradually yellow in color in the meantime.

After this reaction period, the cooling bath was removed to let the temperature return to room temperature and the reaction was allowed to proceeed at room temperature for 3 days while no change was observed apparently except for separation of a solid in a very small amount Thereafter, the reaction was terminated by addition of a small amount of methanol and a uniformly yellow solution was obtained as the reaction mixture.

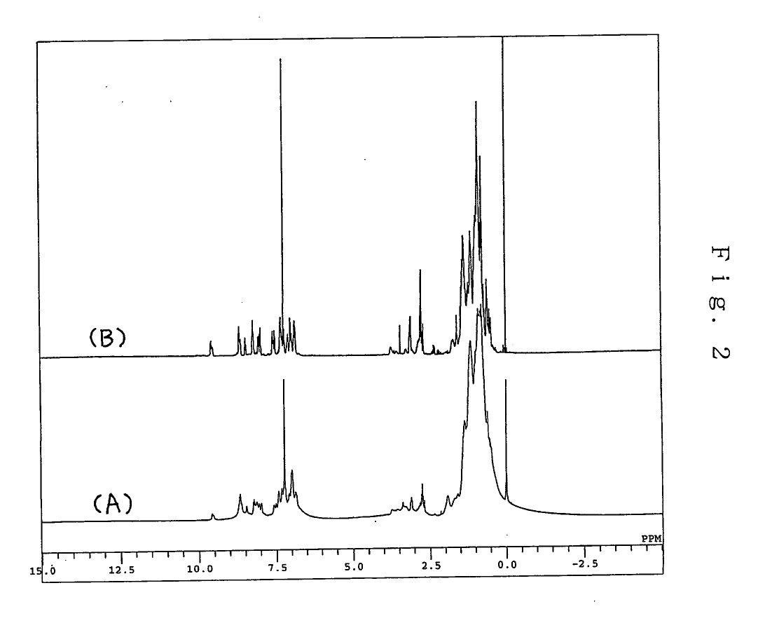

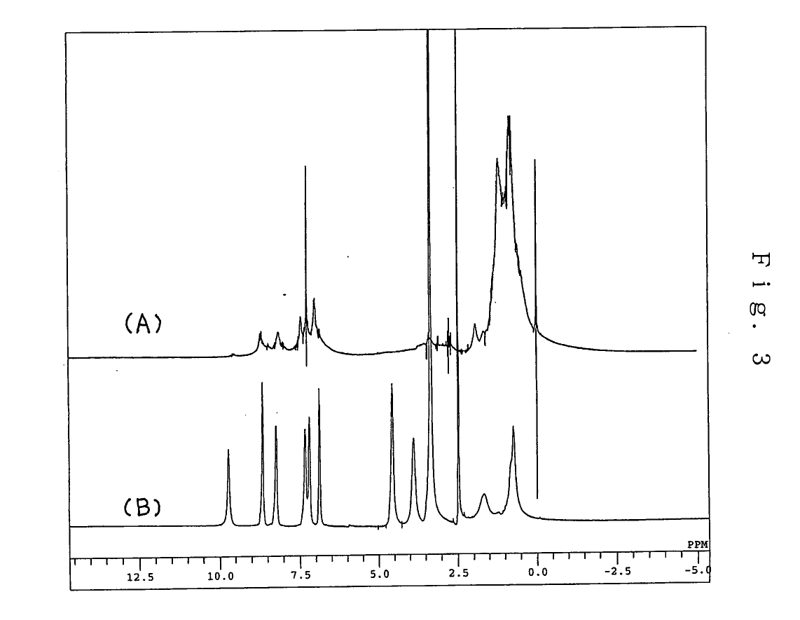

The ¹H-NMR spectrum (400 MHz, CDCl₃) of the reaction mixture is shown in FIG. 2(A). This spectrum contains the spectrum [FIG. 2(B)] of the low-molecular-weight metal complex (LM-C, Al—K₃) in which three equivalents of the low-molecular-weight ligand (K) are coordinated to aluminum. Moreover, the differential spectrum of the reaction mixture and the low-molecular-weight metal complex (LM-C, Al—K₃) shown in Table 3 (A) does not agree with the single spectrum [FIG. 3(B)] of the polymer ligand (polyQ¹).

Therefore, the polymer ligand (polyQ¹) in the reaction mixture is present as an aluminum complex and, theoretically, the reaction mixture is presumed to be an organic polymer metal complex composition comprising 2.53 g (2.78 millimoles) of a polymer metal complex (HM-C) in which 1 equivalent of the polymer ligand (polyQ¹) and 2 equivalents of the low-molecular-weight ligand (K) are coordinated to an aluminum ion (Al³⁺) and 5.12 g (5.62 millimoles) of a low-molecular-weight metal complex (LM-C) in which 3 equivalents of the low-molecular-weight ligand (K) are coordinated to an aluminum ion (Al³⁺) at a molar ratio HM-C/LM-C of 0.5 dissolved in a mixed solvent of 100 mL of THF, 8.4 mL of hexane and 0.1 mL of methanol.

The fluorescent spectrum of the organic polymer metal complex composition obtained in Example 1 was measured by dissolving 0.05 mL of the solution of the comosition in 3 mL of chloroform and using a fluorospectrometer (SHIMADZU RF-5300PC, available from Shimadzu Corporation) and the fluorescent property was recognized [(λₑₓ=400 nm): λₑₘ=533 nm in CHCl₃)]. Furthermore, the solution obtained in Example 1 was cast over a glass plate, air-dried overnight and then dried in vacuum at 50° C. for 12 hours to give a light yellow transparent thin film which also showed the fluorescent property [(λex=400 nm): λₑₘ=533 nm].

### EXAMPLE 2

### Synthesis of Composition polyQ²-Al—K₂+Al—K₃

A reaction mixture was obtained as a uniformly yellow solution in the same manner as in Example 1 except for dissolving 1.12 g (2.5 millimoles) of the polymer ligand (polyQ²) obtained in Synthetic Example 2 and 4.48 g (15.1 millimoles) of 7-(4-ethyl-1-methyloctyl)-8-hydroxyquinoline as a low-molecular-weight ligand (K) in 20 mL of dry THF in a reaction vessel.

The reaction mixture was an organic polymer metal complex composition comprising 2.11 g (1.98 millimoles) of a polymer metal complex (HM-C) in which 1 equivalent of the polymer ligand (polyQ²) and 2 equivalents of the low-molecular-weight ligand (K) are coordinated to an aluminum ion (Al³⁺) and 1.56 g (1.70 millimoles) of a low-molecular-weight metal complex (LM-C) in which 3 equivalents of the low-molelcular-weight ligand (K) are coordinated to an aluminum ion (Al³⁺) at a molar ratio HM-C/LM-C of 1.16 dissolved in a mixed solvent of 20 mL of THF, 6 mL of hexane and 0.1 mL of methanol.

### EXAMPLE 3

### Isolation of polyQ²-Al—K₂

The solution of the organic polymer metal complex composition obtained in Example 2 was added dropwise to 500 mL of methanol with stirring thereby dissolving the low-molecular-weight metal complex (LM-C or Al—K₃) in the methanol and precipitating the crude polymer metal complex (HM-C or polyQ²-Al—K). The precipitates were collected by filtration to recover 2.87 g of a yellow solid, which was further purified by reprecipitation to give 2.11 g (yield 79%) of the polymer metal complex (HM-C or polyQ²-Al—K).

This polymer metal complex is sparingly soluble in a solvent such as methanol, ethanol and hexane and readily soluble in a solvent such as THF, benzene and chloroform. When measured for the fluorescent spectrum as in Example 1, it showed the fluorescent property [(λₑₓ=400 nm): λₑₘ=537 nm in CHCl₃)]. Likewise, the polymer metal complex was cast on a glass plate, air-dried overnight and then dried in vacuum at 50° C. for 12 hours to give a yellow transparent thin film which also showed the fluorescent property [(λₑₘ=400 nm): λₑₘ=537 nm].

In Example 3, the methanol solution remaining after precipitation of the polymer metal complex (HM-C) yielded 1.56 g (yield 34%) of the low-molecular-weight metal complex (Al—K₃) as a yellow viscous liquid.

The low-molecular-weight metal complex (Al—K₃) showed the fluorescent property [(λₑₓ=400 nm): λₑₘ=533 nm in CHCl₃)] when measured for the fluorescent spectrum as in Example 1.

The polymer metal complex (polyQ²-Al—K₂) was submitted to elemental analysis with the following results.

[Elemental Analysis]

Found: C, 73.80; H, 9.39; N, 3.75.

Calcd. for C₆₇H₉₄N₃O₆Al.1.2H₂O: C, 74.07; H, 8.95; N, 3.87.

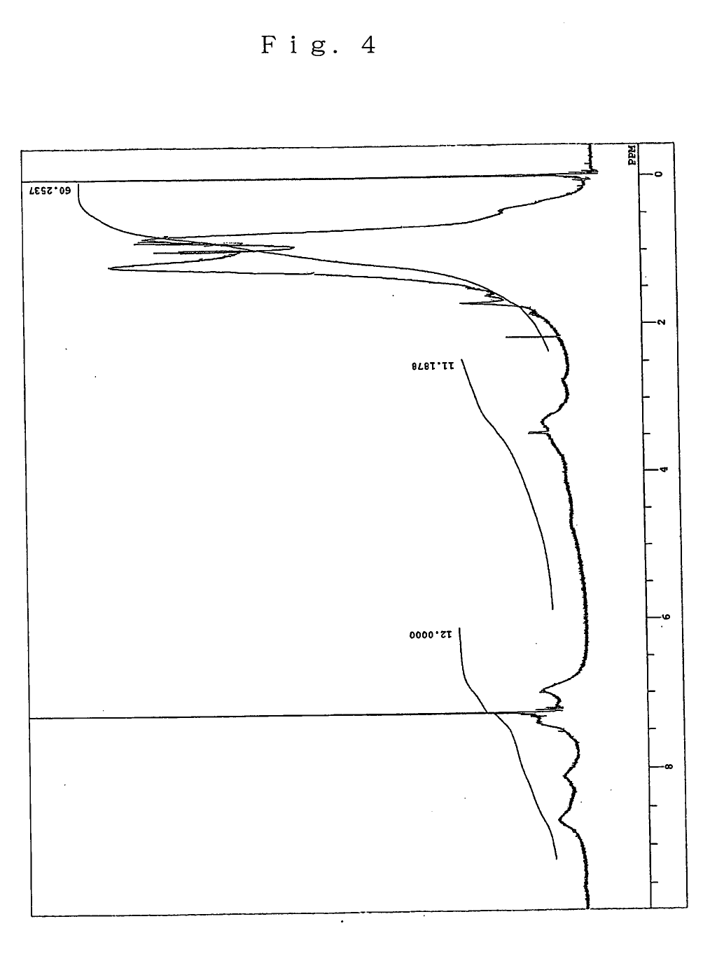

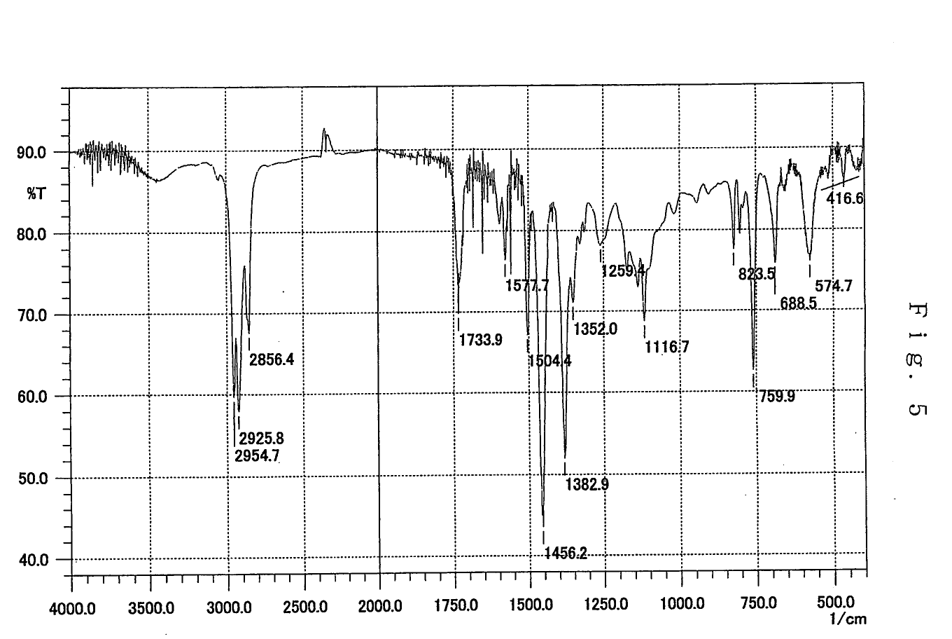

The ¹H-NMR spectrum (400 MHz, CDCl₃) is shown in FIG. 4 and the IR absorption spectrum in FIG. 5.

### EXAMPLE 4

### Synthesis of polyQ²-Al—K₂

The reaction of the polymer (polyQ²) obtained in Synthetic Example 3 and the low-molecular-weight ligand (K) with trimethylaluminum was carried out at room temperature for 5 hours and terminated by addition of 3 mL of methanol to give a yellow reaction mixture in the same manner as in Example 1 with the exception of dissolving 252 mg (0.57 millimole) of the polymer (polyQ²) and 1.36 g (4.55 millimoles) of 7-(4-ethyl-1-methyloctyl)-8-hydroxyquinoline as a low-molecular-weight ligand (K) in 15 mL of dry THF.

The reaction mixture was filtered, 200 mL of methanol was added to the filtrate and the precipitated solid matter was collected by filtration and dried in vacuum to give 456 mg (yield 75%) of the polymer metal complex (polyQ²-Al—K₂) as a yellow solid.

The ¹H-NMR spectrum of the polymer metal complex (polyQ²-Al—K₂) obtained in this manner agreed well with that of the polymer metal complex (polyQ²-Al—K₂) obtained in Example 3 and shown in FIG. 4.

The polymer metal complex (polyQ²-Al—K₂) obtained here in Example 4 is sparingly soluble in methanol, ethanol, hexane or dimethylformamide and readily soluble in other common organic solvents such as THF, benzene and chloroform. The yellow transparent thin film prepared by applying a THF solution of the polymer metal complex to a glass plate by the spin coating process and air-drying showed the fluorescent property [(λₑₓ=400 nm): λₑₘ=537 nm].

### EXAMPLE 5

### Synthesis of polyQ²-Al—K₂

A solution of 500 mg (1.13 millimoles) of the polymer (polyQ²) obtained in Synthetic Example 3, 2.70 g (9.04 millimoles) of 7-(4-ethyl-1-methyloctyl)-8-hydroxyquinoline as a low-molecular-weight ligand (K) and 0.70 g (3.39 millimoles) of triisopropoxyaluminum [Al(OiPr)3] in 30 mL of dry THF was allowed to react with stirring at room temperature for 1 hour and then at reflux temperature for 12 hours to give a slightly turbid yellow reaction solution.

The reaction solution was filtered, the filtrate was added to 800 mL of methanol, and the precipitates were collected by filtration and dried to give 430 mg (yield 36%) of the polymer metal complex (polyQ²-Al—K₂) as an amorphous yellow solid.

The polymer metal complex (polyQ²-Al—K₂) thus obtained agreed well with the polymer metal complexes obtained in Examples 3 and 4 in respect to the ¹H-NMR spectrum, solubility, film-forming ability and fluorescent spectrum of thin film.

### INDUSTRIAL APPLICABILITY

A luminescent organic polymer metal complex or a composition thereof prepared according to this invention is an organic metal complex of the Alq₃ type characterized not only by its excellent fastness, polychroism and brightness but also by its excellent solvent solubility suitable for the production of large-area thin film by a wet process and is industrially extremely useful as a material for the luminescent layer of an organic electroluminescent element (organic EL element).

1. A luminescent organic polymer metal complex obtained by the reaction of a polymer ligand (polyQ) having a repeating unit (Y) with an 8-hydroxyquinoline derivative (Q) introduced to its side chain, if necessary, through a spacer group (X), a low-molecular-weight ligand (K) consisting of an 8-hydroxyquinoline derivative (K) and a divalent to tetravalent metal ion (Mⁿ⁺) and represented by the following general formula (1)
polyQ.M.Kₙ₋₁ (1)
wherein said 8-hydroxyquinoline derivative (K) is represented by the following general formula (2); 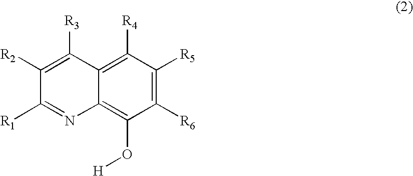
in formula (2), R₁—R₆ are substituents selected from hydrogen, halogens, saturated or unsaturated hydrocarbon groups containing 1-20 carbon atoms and having a linear, branched or annular structure or a mixed structure thereof, alkoxy groups containing 1-20 carbon atoms, alkylamino groups containing 1-20 carbon atoms, alkylthio groups containing 1-20 carbon atoms, alkylsulfonyl groups containing 1-20 carbon atoms, alkyloxyalkyl groups containing 2-20 carbon atoms, alkylthioalkyl groups containing 2-20 carbon atoms, alkanoyl groups containing 2-20 carbon atoms, aroyl groups, monoalkylaminoalkyl groups containing 2-20 carbon atoms, dialkylaminoalkyl groups containing 3-20 carbon atoms, phenylazo groups whose functional groups are substituted or unsubstituted, anilinoalkyl groups whose functional groups are substituted or unsubstituted and —SO₃Na and at least one of the substituents R₁, R₃, R₄ and R₆ is a bulky substituent other than hydrogen, halogens and —SO₃Na.

2. A luminescent organic polymer metal complex as described in claim 1 wherein at least one of the substituents R₁, R₄ and R₆ in said 8-hydroxyquinoline derivative (K) represented by formula (2) is a bulky substituent selected from saturated or unsaturated hydrocarbon groups containing 6-20 carbon atoms and having a linear, branched or annular structure or a mixed structure thereof, alkyloxyalkyl groups containing 2-20 carbon atoms, alkanoyl groups containing 2-20 carbon atoms, dialkylaminoalkyl groups containing 3-20 carbon atoms, phenylazo groups whose functional groups are substituted or unsubstituted and anilinoalkyl groups whose functional groups are substituted or unsubstituted.

3. A luminescent organic polymer metal complex as described in claim 1 wherein said 8-hydroxyquinoline group (K) is 7-(4-ethyl-1-methyloctyl)-8-hydroxyquinoline or 7-(1-vinyl-3,3,6,6-tetramethyhexyl)-8-hydroxyquinoline.

4. A luminescent organic polymer metal complex as described in claim 1 wherein said divalent to tetravalent metal ion (Mⁿ⁺) is Al³⁺, Ga³⁺ or Be²⁺.

5. A luminescent organic polymer metal complex composition formable into film by a wet process comprising a polymer metal complex (HM-C) represented by formula 1) described in claim 1 and a low-molecular-weight metal complex (LM-C) represented by the following general formula (3)
M.Kₙ (3)
in which only a low-molecular-weight ligand (K) consisting of an 8-hydroxyquinoline derivative (K) is coordinated to a divalent to tetravalent metal ion (Mⁿ⁺) wherein said 8-hydroxyquinoline derivative (K) is represented by the following general formula (2); 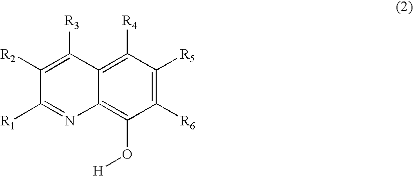
in formula (2), R₁—R₆ are substituents selected from hydrogen, halogens, saturated or unsaturated hydrocarbon groups containing 1-20 carbon atoms and having a linear, branched or annular structure or a mixed structure thereof, alkoxy groups containing 1-20 carbon atoms, alkylamino groups containing 1-20 carbon atoms, alkylthio groups containing 1-20 carbon atoms, alkylsufonyl groups containing 1-20 carbon atoms, alkyloxyalkyl groups containing 2-20 carbon atoms, alkythioalkyl groups containing 2-20 carbon atoms, alkanoyl groups containing 2-20 carbon atoms, aroyl groups, monoalkylaminoalkyl groups containing 2-20 carbon atoms, dialkylaminoalkyl groups containing 3-20 carbon atoms, phenylazo groups whose functional groups are substituted or unsubstituted, anilinoalkyl groups whose functional groups are substituted or unsubstituted and —SO₃Na and at least one of the substituents R₁, R₃, R₄ and R₆ is a bulky substituent other than hydrogen, halogens and —SO₃Na.

6. A luminescent organic polymer metal complex composition formable into film by a wet process as described in claim 5 wherein at least one of the substituents R₁, R₄ and R₆ in said 8-hydroxyquinoline derivative (K) represented by formula (2) is a bulky substituent selected from saturated or unsaturated hydrocarbon groups containing 6-20 carbon atoms and having a linear, branched or annular structure or a mixed structure thereof, alkyloxyalkyl groups containing 2-20 carbon atoms, alkanoyl groups containing 2-20 carbon atoms, dialkylaminoalkyl groups containing 3-20 carbon atoms, phenylazo groups whose functional groups are substituted or unsubstituted and anilinoalkyl groups whose functional groups are substituted or unsubstituted.

7. A luminescent organic polymer metal complex composition formable into film by a wet process as described in claim 5 wherein said 8-hydroxyquinoline derivative (K) is 7-(4-ethyl-1-methyloctyl)-8-hydroxyquinoline or 7-(1-vinyl-3,3,6,6-tetramethyhexyl)-8-hydroxyquinoline.

8. A luminescent organic polymer metal complex composition formable into film by a wet process as described in claim 5 wherein said divalent to tetravalent metal ion (Mⁿ⁺) is Al³⁺, Ga³⁺ or Be²⁺.

9. A luminescent organic polymer metal complex composition formable into film by a wet process as described in claim 5 wherein the molar ratio of said polymer metal complex (HM-C) represented by formula (1) to said low-molecular-weight metal complex (LM-C) or the molar ratio HM-C/LM-C is 0.2 or more.

10. A method for producing a luminescent organic polymer metal complex composition formable into film by a wet process which comprises carrying out the reaction of 1 equivalent of a compound of a divalent to tetravalent metal, 0.1-1 equivalent of a polymer ligand (polyQ) having a repeating unit (Y) with an 8-hydroxyquinoline derivative (Q) introduced to its side chain, if necessary, through a spacer group (X) and 1-3.9 equivalents of a low-molecular-weight ligand (K) consisting of an 8-hydroxyquinoline derivative (K) represented by the following general formula (2) 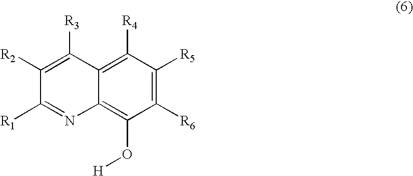
in a solvent to produce an organic polymer metal complex composition consisting of a polymer metal complex (HM-C) represented by the following general formula (1)
polyQ.M.Kₙ₋₁ (1)
in which a polymer ligand (polyQ) and a low-molecular-weight ligand (K) are coordinated to a divalent to tetravalent metal ion (Mⁿ⁺) and a low-molecular-weight metal complex (LM-C) represented by the following general formula (3)
M.Kₙ (3)
in which said low-molecular-weight ligand (K) alone is coordinated to a divalent to tetravalent metal ion (Mⁿ⁺); in formula (2), R₁—R₆ are substituents selected from hydrogen, halogens, saturated or unsaturated hydrocarbon groups containing 1-20 carbon atoms and having a linear, branched or annular structure or a mixed structure thereof, alkoxy groups containing 1-20 carbon atoms, alkylamino groups containing 1-20 carbon atoms, alkylthio groups containing 1-20 carbon atoms, alkyloxyalkyl groups containing 2-20 carbon atoms, alkylthioalkyl groups containing 2-20 carbon atoms, alkanoyl groups containing 2-20 carbon atoms, aroyl groups, monoalkylaminoalkyl groups containing 2-20 carbon atoms, dialkylaminoalkyl groups containing 3-20 carbon atoms, phenylazo groups whose functional groups are substituted or unsubstituted, anilinoalkyl groups whose functional groups are substituted or unsubstituted and —SO₃Na and at least one of the substituents R₁, R₃, R₄ and R₆ is a bulky substituent other than hydrogen, halogens and —SO₃Na.

11. A method for producing a luminescent organic polymer metal complex composition formable into film by a wet process as described in claim 10 wherein said compound of a divalent to tetravalent metal is a trialkylaluminum or trialkoxyaluminum.

12. A method for producing a polymer ligand (polyQ) having a repeating unit (Y) with an 8-hydroxyquinoline derivative (Q) introduced to its side chain, if necessary, through a spacer group (X) which is based on the sequence of the chloromethylation of an 8-hydroxyquinoline derivative (Q), the reaction of the chloromethylated 8-hydroxyquinoline derivative with a hydroxyalkyl (meth)acrylate to give an 8-hydroxyquinoline derivative containing a polymerizable substituent and the polymerization of the alkoxy (meth)acrylate group in said derivative and comprises reacting the hydroxyl group at the position 8 of said 8-hydroxyquinolien derivative containing a polymerizable substituent with a trialkylsilyl halide to introduce a trialkylsilyl group, the allowing the alkyloxy (meth)acrylate group to polymerize in the presence of an initiator and eliminating the trialkylsilyl group from the resulting polymer.
